(19) United States
(12) Patent Application Publication
(10) Pub. No.: US 2021/0000097 A1
(43) Pub. Date: Jan. 7, 2021

(54) INTEGRATED SYSTEM FOR CONTROLLING, DETECTING, MONITORING, EVALUATING AND TREATING CROP PESTS

(71) Applicants: Gerardo R. MARCHESINI, Sunchales (AR); Ezequiel Manavela CHIAPERO, Rafaela (AR); Luciana V. BOLLATI, Rafaela (AR); Walter Daniel SEQUEIROS, Cordoba (AR)

(72) Inventors: Gerardo R. MARCHESINI, Sunchales (AR); Ezequiel Manavela CHIAPERO, Rafaela (AR); Luciana V. BOLLATI, Rafaela (AR); Walter Daniel SEQUEIROS, Cordoba (AR)

(21) Appl. No.: 16/761,426

(22) PCT Filed: Nov. 7, 2018
(86) PCT No.: PCT/IL2018/051192

§ 371 Date: May 4, 2020

Related U.S. Application Data
(60) Provisional application No. 62/582,322, filed on Nov. 7, 2017.

(51) Int. Cl. A01M 1/02; A01M 1/14; B64F 1/12; A01M 7/00; B64D 47/08; A01M 9/00; B64D 1/18

(52) U.S. Cl. CPC A01M 1/026; A01M 1/14; B64F 1/12; A01M 7/0089; B64D 47/08; B64C 27/325; A01M 7/0014; B64D 1/18; B64C 2201/12; B64C 2201/141; A01M 9/0092

(57) ABSTRACT

An automated system for monitoring and treating pests in a crop field, comprising at least one trap for monitoring and identifying pests, at least one UA V containing at least one chemical or biological products; a home base for parking or storing said at least one UA V when they are not operating; at least one database server; and equipment for communicating with said at least one trap, said at least one home base, said at least one UA V and said at least one database server.

### FIELD OF THE INVENTION

The present invention relates to monitoring systems for the detection, evaluation and treatment of crop pests, and more specific to a system based on smart traps and UAVs for the detection, evaluation and treatment of crop pests.

### BACKGROUND OF THE INVENTION

There are two major problems related to the existence and propagation of pests in agricultural activity that have been demanding answers for some time and do not have an integrated solution. On the one hand, the implementation of an early warning of the appearance of the pest, to avoid economic losses due to the damage they cause to the crop. On the other hand, the efficient control (application of agrochemicals or biological products) of the same.

The different monitoring tools (visual observation, beating, traps, etc.) have had different degrees of success but they require intensive manual work. In addition, the time elapsed between the appearance of the pest, monitoring, data analysis, decision-making and application of agrochemicals or biological products to control the pest, creates a delay of 7-15 days generating pest proliferation, resurgence and excessively expanding the area of application.

Intensive monitoring of crops is done with traps having pheromones to attract the plague to a sticky trap and later on and operator visually counts the amount of captured insects and identifies them. This method is extremely expensive since it needs a great amount of handwork. The system and method of the present invention will reduce said costs eliminating handwork, providing automatic, geolocated and real time measure and identification of the pest. This allows a real time treatment as well. The pest treatment tool of the present invention can respond immediately once the pest is detected by the traps.

The combination of these two elements working together opens the possibility of treating only the endangered zone when needed and not the entire farm, reducing the use of agrochemicals or biological products from about 20% to 90%.

Patent application CN101800888 A discloses a device for monitoring plant diseases and insect pests by utilizing the wireless communication technology and a monitor method, belonging to the technical field of electronic information. The device comprises a wireless sensor network, a monitor terminal, a camera holder and an information service platform, wherein sensor nodes of the wireless sensor network are distributed in the agriculture area required the monitoring of the plant diseases and insect pests; gateway nodes of the wireless sensor network are connected to the monitor terminal through USB interfaces; the camera holder is connected to the monitor terminal; and the monitor terminal is in communication connection with the information service platform in a wireless mode. The invention monitors the plant diseases and insect pests through the sensor network, utilizes the monitor terminal to send picture information of the plant diseases and insect pests to the information service platform through the wireless network, and then further reaches the most suitable agriculture organization and experts, thereby obtaining the timely approaches and suggestions of the prevention and treatment of the plant diseases and insect pests, and having positive significances on the timely and effective monitoring and preventing and curing of the plant diseases and insect pests.

Utility model CN205120712 U discloses an intelligence vegetation monitoring devices, it includes intelligent control ware, plant diseases and insect pests monitor, and the trunk position of being fixed in the plant is bind through the strapping respectively to intelligent control ware, plant diseases and insect pests monitor, and plant diseases and insect pests monitor is connected with intelligent control ware electricity, the intelligent control ware is joined in marriage dress soil moisture and is contained level sensor including level sensor, trunk moisture, and soil moisture contains level sensor, trunk moisture contains level sensor and is connected with intelligent control ware electricity respectively, dress LED warning light, wireless communication module are joined in marriage to the intelligent control ware, and LED warning light, wireless communication module are connected with intelligent control ware electricity respectively. Through the structure design, the utility model discloses can monitor plant growth process effectively, when the vegetation appearance is unusual, also can remind effectively to ensure the survival rate of plant, therefore, the utility model has the advantages of structural design is novel, intelligent degree is high.

Patent application WO 1996029875 A1 discloses an insect monitoring system or trap and related method and more particularly though not exclusively to a system for monitoring and trapping pests which feed off umbelliferous plants. In accordance with an aspect of the invention, an insect monitoring system or trap which incorporates a plant volatile as a chemical attractant. In order to attract the insect to the trap it is preferred to use at least two chemical attractants at least one of which is a plant volatile. Preferably, the at least two, chemical attractants include a longer range semio-chemical attractant which is a substantially volatile compound and a shorter range semio-chemical attractant which is a substantially less-volatile compound.

Patent application CN103760847A discloses an insect attack remote monitoring system which comprises an environment data acquisition unit, a plurality of sensors of different types, a plurality of sex lure devices, a plurality of color lure devices, an image acquisition unit, a monitoring unit and a data processing unit. Each sex lure device is provided with a sex lure agent and a light sensation counter, each color lure device is provided with a color lure agent, the monitoring unit regularly receives and stores environment data from the environment data acquisition unit, data from the light sensation counters and image data from the image acquisition unit, and the data processing unit processes the data from the monitoring unit to obtain a corresponding relation between the number of injurious insects and the environment data. Through the insect attack remote monitoring system, the relation between the environment change of an area and the insect attack can be grasped accurately, the habitual natures and characteristics of certain plant diseases and insect pests can be grasped, full-scale data support is provided for scientific research on plant diseases and insect pests, and effective prevention and treatment of the plant diseases and the insect pests are facilitated. The invention further discloses a method for carrying out insect attack monitoring by using the system.

Patent application CN105739518A discloses an insect disease monitoring system based on unmanned plane multispectral remote sensing, belongs to the unmanned plane, communication, electronic, computer, chemical and agronomy fields and solves problems of time consuming, labor consuming, low efficiency, high cost and poor timeliness existing in a traditional insect disease monitoring system. According to the system, the unmanned plane embarcation remote sensing equipment is employed to accomplish insect disease monitoring, and the whole system comprises subsystems of an unmanned plane system, a multispectral remote sensing system, a data link system, a ground control system and an application system, can accomplish rapid data acquisition and timely generates data analysis reports. Through the system, images reflecting the insect disease situation can not only be displayed in real time, but also species identification can be carried out according to spectrum characteristics of different insects and vegetations.

These and other patent documents do not disclose the embodiments of the present invention which far surpasses the current partial solutions, both from the technical as well as the economic, thereby responding to a long-felt need in the field of crop pests monitoring and treatment.

### SUMMARY OF THE INVENTION

It is within the scope of the present invention to disclose An automated system for monitoring and treating pests in a crop field; said system comprising: (a) at least one trap for monitoring and identifying pests; said at least one trap having known coordinates; said at least one trap comprising: (i) a pest attraction component; (ii) an adhesive pad configured for immobilizing attracted pests; (iii) a sensor arrangement for locating and identifying said attracted pests; (b) at least one UAV comprising: (i) means for carrying and dispensing at least one chemical; (ii) a positioning unit for tracking coordinates of said at least one UAV at all times; (c) a home base for parking or storing said at least one spraying UAV; (d) at least one database server; (e) a communication unit interconnecting said at least one trap, said at least one home base, said at least one UAV and said at least one database server; (f) software configured for creating and maintaining a map of said pests detected and identified by said at least one trap having known coordinates in said crop field and cultivated plants therewithin; said software configured for determining desirable pest control measures applicable to said crop field and cultivated plants therewithin by means of said at least one UAV carrying and dispensing at least one chemical; (g) a flight controller for controlling said at least one UAV according to pest control measures by determined by said software.

It is within the scope of the present invention to disclose the system where the aforementioned pest detection and identification component comprises at least one sensor.

It is within the scope of the present invention to disclose the system wherein the aforementioned identification component comprises an identification information software and database located on said server database.

It is within the scope of the present invention to disclose the system wherein the aforementioned at least one UAV is configured to have a flight length capacity from about 35 minutes to about 65 minutes, carry a cargo from about 10 liters to about 200 liters and achieve a speed from about 30 km/h to about 80 km/h.

It is within the scope of the present invention to disclose system wherein the aforementioned at least one UAV is able to sustain a constant and uniform payload/takeoff-weight ratio between 0.3 and 0.8 for at least 10 minutes.

It is within the scope of the present invention to disclose the system wherein the aforementioned at least one UAV has a specific energy capacity over 400 kJ/kg

It is within the scope of the present invention to disclose system wherein the aforementioned at least one UAV is configured to autonomously apply any liquid/solid/gaseous compound for the purpose of preserving or increasing the crop production within one metre of a predefined target under field conditions as described.

It is within the scope of the present invention to disclose the aerial vehicle comprising a vertically oriented combustion engine to a plane generated formed by arms supporting rotors.

It is within the scope of the present invention to disclose the aerial vehicle having four rotors and said arms form an X-shaped structure.

It is within the scope of the present invention to disclose rotors producing rudder type rotation with lifting forces.

It is within the scope of the present invention to disclose fix angle inclined rotors providing Drag forces and Lift to compensate a torque of the engine.

It is within the scope of the present invention to disclose rotor axes inclined by an angle up to 15° relative to an engine shaft.

It is within the scope of the present invention to disclose a power train comprising a combination of said main gear, bevel gears and cardan joints to distribute power to the rotors.

It is within the scope of the present invention to disclose aerial vehicle comprising a main gear distributing rotating torque to each rotor.

It is within the scope of the present invention to disclose a method of automated monitoring and treating pests in a crop field where at least one trap is used for monitoring and identifying pests and at least one UAV is used to carry out treatment tasks and wherein the method includes at least the operations of: receiving activation alert and pest related information from said at least one trap; accepting from an user a service order to carry out a treatment task on a field or on plants being farmed due to the activation of said at least one trap; creating and maintaining a map of the field and plants being farmed using precise coordinates from said at least one trap; using said map to transform said service order into assignments for said at least one UAV to perform on all or part of the field or for one or more of the plants being farmed; tracking the precise coordinates of said at least one trap and said at least one UAV at all times; using said precise coordinates to automatically plot assignments for said at least one UAV and then simultaneously directing said at least one UAV to proceed along individual paths to individual points in the field and to perform a treatment task beginning at those points; controlling traffic as said at least one UAV travel so said at least one UAV avoid colliding with other UAVs or with people or other things; and directing said at least one UAV to a home base for automatic parking or storage when no longer needed.

It is further a scope of the present invention to disclose the method where said step of creating and maintaining a map of the field and plants being farmed using precise coordinates from said at least one trap is performed either at the moment of the installation of said at least one trap or at the moment of receiving said activation alert.

### BRIEF DESCRIPTION OF THE FIGURES

FIG. 1 discloses a schematic presentation of the system of the present invention;

FIG. 2 discloses a schematic presentation of the trap of the present invention;

FIG. 3 discloses a schematic presentation of the transmission mechanism of the UAV.

FIG. 4 discloses a schematic presentation of another transmission mechanism of the UAV;

FIG. 5 discloses a schematic presentation of the propeller governor system of the UAV;

FIG. 6 is a perspective view of the UAV;

FIG. 7a is a side view of the UAV;

FIG. 7b is a graph illustrating rotor inclination;

FIG. 8 is a functional diagram of the present invention; and

FIG. 9 is a schematic diagram of a UAV power train.

### DETAIL DESCRIPTION OF THE PREFERRED EMBODIMENTS

The following description is provided, so as to enable any person skilled in the art to make use of said invention and sets forth the best modes contemplated by the inventor of carrying out this invention. Various modifications, however, are adapted to remain apparent to those skilled in the art, since the generic principles of the present invention have been defined specifically to provide system and methods to monitor, detect, evaluate and treat pest activity in crops.

The term “about” refers hereinafter to ±20% of the mentioned value.

The present invention discloses an innovative system for the control, detection, monitoring, evaluation and treatment of crop pests. The system is configured to perform the tasks almost autonomously, with minimal intervention and supervision of the user, allowing an effective and fast response against pests.

The present invention provides advantages from the technical and from the economic point of view, considering both the cost of the application service and the cost of acquisition of the aforementioned systems. The entire system is unified by means of a dedicated software platform in the cloud. This platform interacts with various users and has specific functions for each stage of the control process. The software platform also has secondary functions that involve different operations that will be disclosed below.

The present invention also discloses traps that are enabled to detect, quantify and identify pests using a macro lens camera, when they enter the same. The trap differs from prior art traps as the macro picture provide precise crucial like sex of the insect and state of pregnancy that help in deciding the correct treatment against the pest. The traps of the present invention have an ecological and efficient power system, using green-energy that allows the continuous recharge of the batteries that powers the electronic system of the trap, increasing their durability to months, without the need for replacement. For all these reasons and more that will be described below, the system of the present invention provides a system and methods to accurately and sensibly identify and quantify pests in the crops.

It is herein noted that the term UAV (Unmanned Aerial Vehicles) is interchangeable with the term “drone” and/or UAS (Unmanned Aerial Systems).

It is herein noted that specific energy capacity (ec) is defined as being equal to the maximum power (Pm) of the UAV times the period (T) able to sustain this power delivery divided by the weight of the drone without payload (W). i.e. ec=Pm*T/W>100 kJ/kg

This last relation for ec may be compared with the following approximate values for current airborne vehicles:

| | |
|---|---|
| DJI AGRAS | ec = 156 kJ/kg |
| Regular Electric UAV | ec = 213 kJ/kg |
| Small Internal Comb UAV | ec = 774 kJ/kg |
| Regular Fumigation Plane | ec = 4400 kJ/kg |
| Regular Small Helicopter | ec = 3200 kJ/kg |

### The System

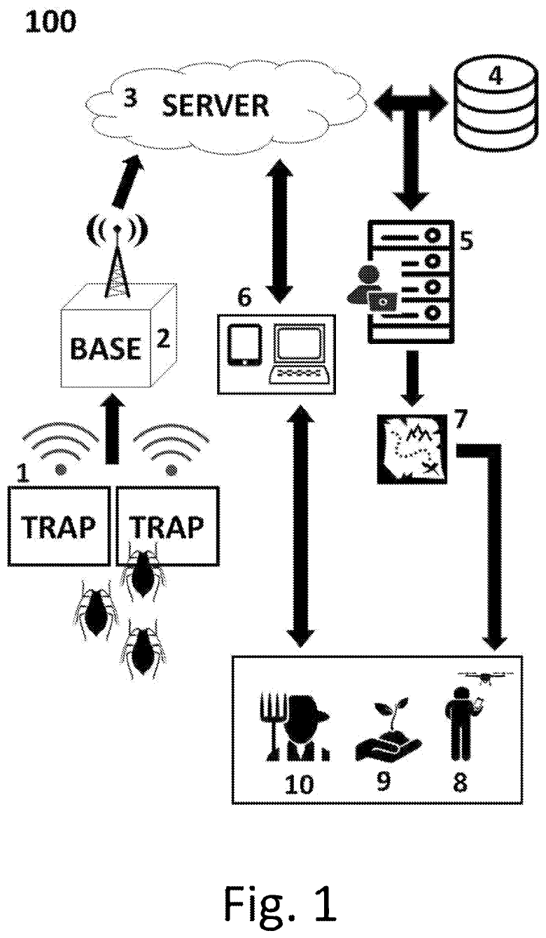

Reference is now made to FIG. 1 showing a schematic representation system 100 for monitoring and treating pests in a crop field. System 100 is an integrated system is directed to automated pest monitoring and control technologies. It comprises a monitoring component, a pest control component and adapted communication and sharing software.

The monitoring component 1 is a trap that incorporates: an insect attraction system comprising pheromones and other attractive elements and an insect detection system comprising a series of electronic sensors such us and infrared, capacitive or piezoelectric array. Once the insect is detected, the system is activated and analysis of the pest morphometric characteristics is performed by Once the pest is identified and quantified, the information is sent to a base 2 that is placed in the field by wireless network. The base 2 receives information from several monitoring components 1. This information is sent in real time to a central server 3, which stores all information from the base, via wireless networks. Dedicated pest identification algorithms allocated in dedicated databases 4 and analysis and processing centers 5 evaluate affected areas and a pest alerts are triggered and reported to the user's devices 6, while generating an autonomous flight plan 7 for immediate treatment by means of application UAVs 8—the pest control component (see detail below). Once the alert is validated, a message is sent to the user (agronomist 9, producer 10) to approve the agrochemical or biological product application procedure (7-8). Once the area to be worked is defined and approved, the UAVs autonomously begin executing said flight plans and distributing the pest treatment material.

All the traps 1 form an integral system of monitoring within each establishment. The amount and arrangement thereof will depend on the surface to be monitored and the type of crop (intensive or extensive). Each field to be treated must have a central base 2 that receives and stores information from each trap 1, which is then sent to the central server 3. According to one embodiment of the present invention, coordinates of traps 1 are known and registered in databases 4.

The traps 1 may have energy storage systems or direct connection to the power line. They also may include additional climate information sensors like: temperature, humidity, direction and wind intensity. This information will be used for calculating the flight plans. The traps 1 also have an additional information storage system in dedicated memory storage units that guarantee the permanence of data in case of communication failure.

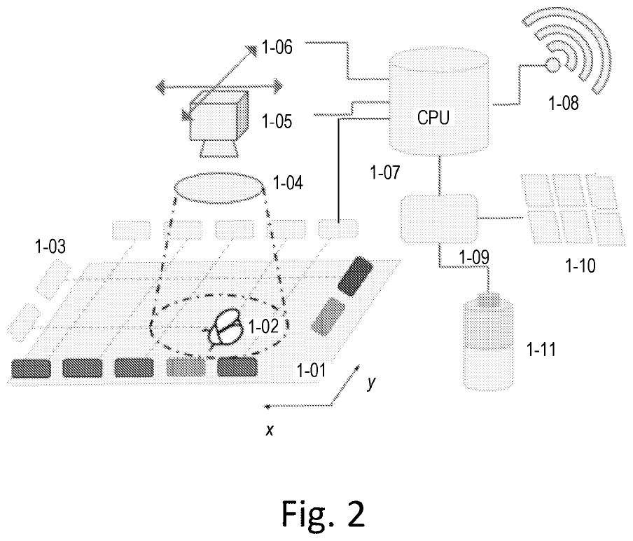

Reference is now made to FIG. 2 presenting a schematic diagram a sensing arrangement. The arrangement comprises adhesive pad 1-01 having a surface of cardboard or plastic coated with entomological gluing agent. The aforesaid agent provides the adherence of insects 1-02 entering the trap. The glue allows the insect to be immobilized such that the insect is detected and photographed.

The sensor arrangement comprises a sensor configured for locating said pests on said pad 1-01 and a macrolens camera 1-05. Pad 1-01 and macrolens camera 1-05 are movable relative to each other such that located pests are in a field of view of said macrolens camera 1-05. The locating sensor comprising a line array of light sources 1-04 and a line array of light detectors 1-03 mounted at edges of said pad opposite one another. Pests 1-01 are located according to detecting by said light detectors a shadow created by pests 1-01 within light beams created by said light sources.

Specifically, in the case of the use of optical sensors, the sensors are located above the adhesive surface 1-01 in the form of a grid. When the insect sticks to the sticky surface, the light beams crossing the area where the insect is located are cut and, in this way, the coordinates for the location of the insect are determined. The grid can be arranged in a circular or rectangular shape, where the sensors will be located in compartments isolated from sunlight, transmitting and receiving IR signals and avoiding or attenuating the entry of sunlight. This method allows to use one or more receptor for each light source.

In the case of using piezoelectric sensors, the array of sensors is distributed covering whole capture surface in the form of a grid. Each independent sensor has a certain amount of glue to catch the insect. When an insect is caught it produces vibrations (escape movements) that activate the sensor. The location of each sensor is stored inside the CPU to be able to recognize the location of each capture. With this type of sensor the trap system can be most of the time in sleep mode until a given piezoelectric sensor detects an insect. The system turns on when a capture is detected in a sensor.

In the case of using capacitive sensors, the sensors are distributed forming an array which covers the capture surface in the form of a grid. Each independent sensor has a portion of glue to catch the insect. The moment an insect is trapped changes the dielectric capacity of the sensor and is activated. The location of each sensor is stored inside the CPU to be able to recognize the location of each capture. The system turns on when a capture is detected in a sensor.

The camera moves by means of a mechanical system that allows it to be located above the captured insect. In this way, once the location of the insect is determined by the sensors, the mechanical system moves to that location so that the camera takes the insect image. The mechanical system can move along the entire area of the trap between axes x and y. Moving the adhesive pad relative to the macrolens camera is also in the scope of the present invention.

A camera macrolens is characterized by a focal length between 30 mm to 400 mm. The obtained images provide morphological details of the insect such as: coloration, texture, size, genitalia (determination of sex), and presence of fecundated females. In this way, we have precise morphological information of the insect and complementary information such as sex ratio, reproduction rate and fertilization. This morphological information provides all data for a precise identification algorithm.

All systems and mechanisms are controlled by a CPU microcontroller 1-07 that coordinates the processes to perform a correct detection and identification of insects. These processes are detailed below:
Turning on the system in the case of using the grid of light sensors. Microcontroller 1-07 has a clock to determine the periodicity with which the system records the catches of insects. Once turned on, it performs all the processes and shuts down until the beginning of a new cycle, optimizing the use of energy.
In the case of piezoelectric or capacitive sensors, the system is switched on with the activation of the sensors themselves.
Insect detection. By analyzing the interruption pattern provided by the grid sensors, the software inside the microcontroller can detect if a new capture took place and determine the coordinates of its position. This detection mode may vary depending on the sensors used for this action. Eg Piezoelectric, capacitive, etc.
Camera movement. The camera is mounted on an electromechanical system that allows mobility on 2 axes. With the coordinates of the location of the insect, the microcontroller makes the appropriate movements so that it is located above that position.
Obtaining images and transmission. With the camera correctly located, the system proceeds to obtain the digital image of the area of interest. Immediately after, this image is stored and transmitted by means of radiofrequency so that the pest can be identified in a server manually or automatically.
The system goes into standby mode until a new cycle begins (either by the clock or by detection).

The obtained data is transmitted to a processing center by radio-frequency transmitter 1-08. Controller 1-07 is energized by lithium battery 1-11 rechargeable by photovoltaic battery 1-10. Numeral 1-09 refers to a power controller.

The present invention discloses at least two types of UAV with at least two different power systems. The first one is a gasoline mono-engine multi propeller UAV. The second one is an electric multi-engine multi propeller UAV. The UAVs can be deployed in the necessary places or outbreaks of appearance of the pest, saving time and agrochemicals or biological products. Using this method do not present health risks since during the deployment the operator is at a safe distance. Finally, the UAVs are easy to carry, allowing almost immediate action.

On one hand, electric-based engines UAVs of the present invention display high quality of anti-pest materials, maneuverability, precision and saving of agrochemicals or biological products, as shown by field-test results. On the other hand, these types of UAVs have disadvantages, like less autonomy time and less load capacity. This is because the batteries do not deliver enough energy to lift heavy loads for prolonged periods of time. For this reason, the second type of UAVs of the present invention solves these problems by providing a novel internal combustion mono-engine.

The UAV is designed as a multicopter machine with internal combustion engines that use liquid fuel (e.g.: gasoline), with flight length capacity from about 35 minutes to about 65 minutes, carry a cargo from about 20 liters to about 30 liters and a achieve speed from about 35 km/h to about 50 km/h. The internal combustion engine provides great power and autonomy, with flight efficiency similar to a conventional helicopter.

The flight microcontrollers read the flight paths generated by the server. These controllers have a specific firmware that is modified to have functions necessary to activate the application system. The UAV comprises a GPS system and flight paths that allow, through a supervised autonomous flight, precise application in confined areas.

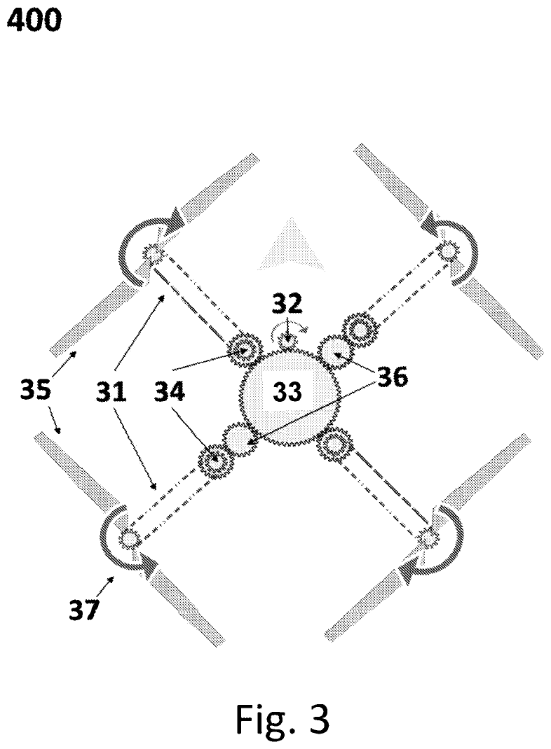

Reference is now made to FIG. 3 showing a schematic representation (not in scale) of the mechanical transmission mechanism 400. In one embodiment the transmission mechanism comprises a variety of sprockets and belts 31. The engine transmits the power through a specific sprocket 32 to a central sprocket 33, which further transmits the power to secondary sprockets 34 interconnected to the belts 31. At the distal end of each belt 31 another set of sprockets interconnected to the helices 35 or propellers are found. An extra set of sprockets 36 are added to change the directionality 37 of the helices 35. This configuration allows to generate a stable, reliable and easy to pilot flight.

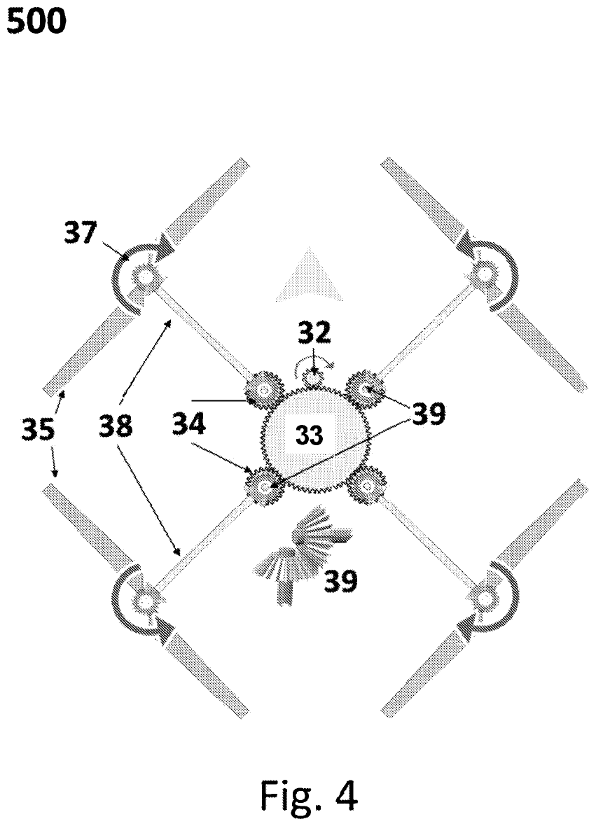

Reference is now made to FIG. 4 showing a schematic representation (not in scale) of another mechanical transmission mechanism 500. In another embodiment the transmission mechanism comprises a variety of sprockets and cardan joints 38. Similar components are marked with the same numbers as in FIG. 3. Same as before, the engine transmits the power through a specific sprocket 32 to a central sprocket 33, which further transmits the power to secondary sprockets 34 interconnected to conical gears 39. Each conical gear 39 is interconnected to a cardan joint 38. At the distal end of the cardan joint 38 another set of sprockets interconnected to the helices 35 or propellers, are found. The directionality 37 of the helices 35 is defined by the type of conical gear 39 used. This configuration also allows to generate a stable, reliable and easy to pilot flight.

Both transmission mechanisms allow the activation of the propellers at the same time and at the same revolutions per minute (RPM). Since the RPM is constant in each propeller, variations in lift are commanded by a variable pitch system (servomotor).

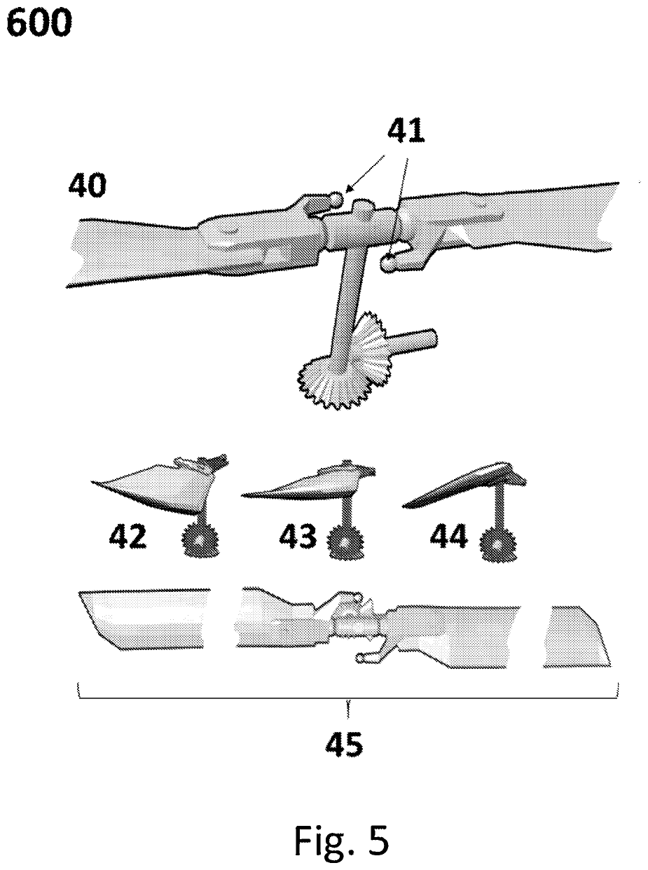

Reference is now made to FIG. 5 showing one embodiment of the propeller governor system 600 of the present invention. In this example, a conical gear connection is shown. The angle of the blade 40 is governed by the arm 41. If the arm is moved upwards, it will result in negative lift 42. If the arm is kept in place, it will result in no lift 43. Finally, if the arm is moved downwards, it will result in positive lift 44 (pitch control). The length of each Blade 45 will depend on the potency of the UAV, and it can vary between about 450 mm to about 1600 mm.

This technology increases the payload capacity by at least 200% and autonomy time by at least 300%, which results in a much greater work capacity than an electric multicopter that uses lithium batteries. It has a high quality of application because its shape of flight the air flow generates turbulences that move the crop facilitating a good penetration of the product. The low dilutions in water avoid the waste of this resource. The flight system has no onboard pilot or unnecessary weight so fuel consumption is decreased. It has a new technology of pressurization for the agrochemical or biological products that eliminates the need of the pump that other UAVs use. This innovation is a new alternative in the methods of application of agrochemicals or biological products that are used today.

The third component—the software—constantly acquires all the information coming from the trap sensors. This information is stored in the database for the following stages of analysis, detection and identification. The information of each trap arrives with an identifier that allows knowing to which client the arriving information belongs.

When several sensors are activated and their information is transmitted to the software, it performs an analysis that determines which species and what amount of pest is present in the zone. If this result exceeds a pest threshold a treatment alert is generated.

When the software determines that a treatment of phytosanitary products and the area to be treated is necessary, the customer receives a treatment alert. This generated alarm is always supervised and authorized by an agronomist/responsible user who reviews the dose and type of agrochemicals or biological products to be used (agronomic recipe). The customer receives this alert and must enter the system, either by the web or app and approve the work. The UAV operator receives all the treatments that must be made through the software, which also provides him with a daily work agenda. The UAV operator, with his system specific user credentials, downloads the flight routes and in each case, he is in charge of supervising the flight of the UAV and informing the system of the result of these treatments.

At any time, a client or operator can request an additional UAV-performed treatment of herbicides, fertilizers or any other phytosanitary product in the field, in which case the software generates an order for the UAV operator's agenda.

Customer reports. The client user can enter the web or App and consult at any time the status of his crop, review historical reports of activities performed and a summary of his expenses account. The user may also request the removal of the traps by dedicated personnel or report the damage of any trap.

The software platform also has functions that involve different service operations, like:
1. Communication Trap Server. Make all the necessary information arrive correctly from the field sensors, to the base and then sent it to the server over the wireless network. This is done in real time, as it is what makes the service efficient and accurate.
2. Identification algorithms. Detailed insect pictures taken by the macro camera of the traps are received by the server. The identification algorithm compares this picture (including morphological details of the insect such as: coloration, texture, size, genitalia, presence of fecundated females) with a huge photo database to accurately determine which is the insect detected.
3. Frontend. Customers have a first screen or graphical interface units (GUI) where they monitor the activation of the sensors, the subsequent treatment plans, expenses and more.
4. Backend. The relevant information may be entered either manually or automatically into the database. A control panel allows a supervisor or operator to enter all installation information, generate application alerts and control all the processes.
5. Flight routes. The system indicates the active sensors, an algorithm analyzes them and demarcate the area necessary for the application. Once the area is delimited, the software generates a flight path for the UAV via waypoints that are used by the UAV autonomous flight system.
6. App. A frontend version for clients and backend for operators is provided in a mobile version for the purpose of facilitating tasks in the field. The communication between app and server is done by web services. The app has the ability to work offline, store the data on the device and transmit it when it finds connectivity.
7. E-commerce and extra functions. Finally, the software includes a payment platform for the service, statements, additional application requests and historical monitoring data.
8. Installation: In general, the user operator, while in the field, enters the system to indicate that a trap sensor was installed, identifying its geographic position and identifying to which customer to which it belongs.
9. Customer Registration. The client can be allowed to access into the system manually by a field or administrative operator, and automatically via e-commerce platform or by downloading the BIODRONE App.

Cloud Server: The software is installed within a dedicated server with high processing capacity due to its complex algorithms. The servers include great storage capacity, with memory expansion capabilities according to the demand of the system.

APP: It is software that will be installed on mobile devices. It is contemplated that the server has web services where the application makes its constant communication.

### Targeted Spraying

In several embodiments, the system is adapted to selectively spray areas determined to be affected or at risk. These areas can include regions surrounding traps having identified the presence of pests. This system of targeted spraying will have the benefit of reducing both costs and environmental impact.

### Big Data Analysis

In several embodiments, the system allows the trap and the UAV to sync with a larger big data framework. The flow of information between the machines in the field and additional local distributed sensors powered by big data greatly expands the system's capabilities. Possible applications include predicting the growth or diminishment of pest outbreaks based on weather forecasts, and automatically spraying neighboring fields when pest outbreaks occur. Big data analysis of the level of beneficial insects like natural predators of the plague will also enable better decision making in order to minimize the use of insecticide. The UAV will gather and relay all the data regarding the agrochemical or biological products being applied and the geo-positioning of the dose applied together with wind speed data derived from the navigation system. This will enable a strong historical registry which is crucial to certify good agricultural practices. The constant monitoring of growing areas of crops allow to generate a database that can be used in the future for the statistical analysis of pest, crop, etc., and study behavior, that allows predicting future demands.

### Multi Users Cross Data Analysis

In several embodiments, the system is adapted to use neighbor's users monitoring data to predict future presence of pests coming from near fields allowing to take preventive actions or to have a better scheduling for the future controls based on the system predictions.

The system integrates monitoring and application, which adds immediate information availability through a software platform that allows optimizing the decision making in real time. The system includes a set of traps and base, with the possibility of identifying the pest, evaluating the affected areas, firing a pest alert that is informed and simultaneously generates an autonomous flight plan for immediate treatment by means of application UAVs. These UAVs possess an innovative system of spraying and dimensions that make agile their manipulation and transport. The application is extremely fast and precise and precise and works in conditions unviable for other technologies (at night, with winds of 30 km/h, soft soil).

The system has the capability to open the airspace at the moment the payment is executed. This enables a full control on the activity of each UAV, secures payment and compliance with all the safety requirements like avoiding UAVs near populated areas, airports, etc.

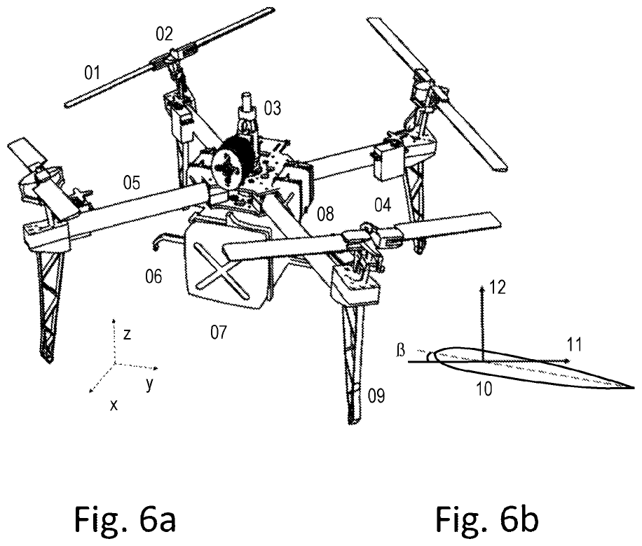

Reference is now made to FIG. 6 (a,b) presenting an aerial vehicle of a multirotor type having an X shaped frame. The aerial vehicle comprises vertically mounted central combustion engine 03 engine fed from fuel tank 08. Rotational torque generated by engine 03 is distributed to rotors 02 mounted at terminals of each arms 05. Rotors 02 are provided with blades 01. Arms 05 are provided with bevel gears (not shown). A chemical accommodated within agrochemical tank 07 is dispensed from spray nozzle 06. The aerial vehicle when landed is supported by skies 09. Blades 01 pitch angle (β) are controlled by servomotors 04. The blade airfoil 10 produce two forces; lift force 12 and drag force 11, controlled by a pitch control (β).

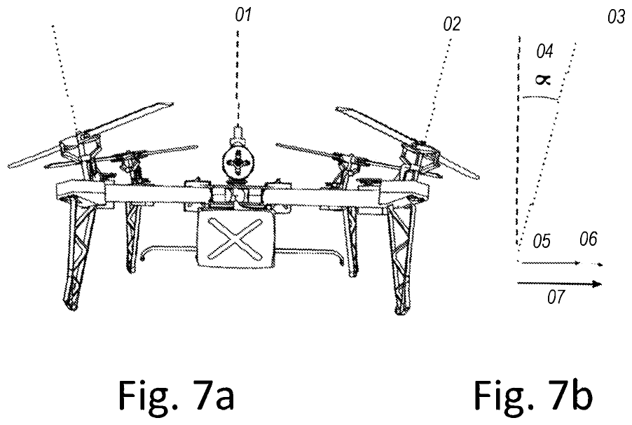

Reference is now made to FIG. 7(a,b) the engine 01 setup wherein the crankshaft is on the Z axis. Each rotor axis 02 are installed in a fix Angle “ [symbol] 04, that produce part of the lift force 05 added to the drag force 06 for total force of yaw control 07. Axis and force schematic 03.

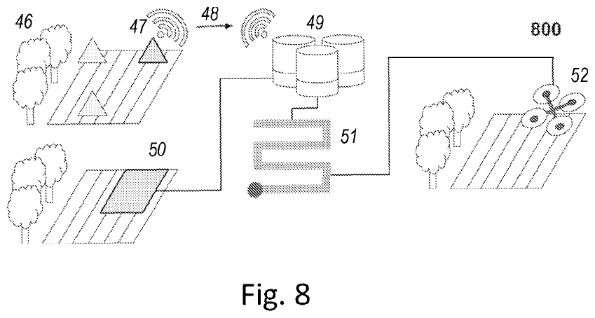

Reference is now made to FIG. 8 showing the embodiment whole system integrated of the present invention. Intelligent traps are geolocated in strategic places of the field 46. Once a trap 47 captures an insect, the picture taken is sent by radiofrequency 48 to software in the cloud 49. An identification algorithm identifies the plague and delimitates a treatment area 50. A second algorithm transforms the treatment area into a flight road 51, and then downloads it to a spraying drone 52 to spray said area.

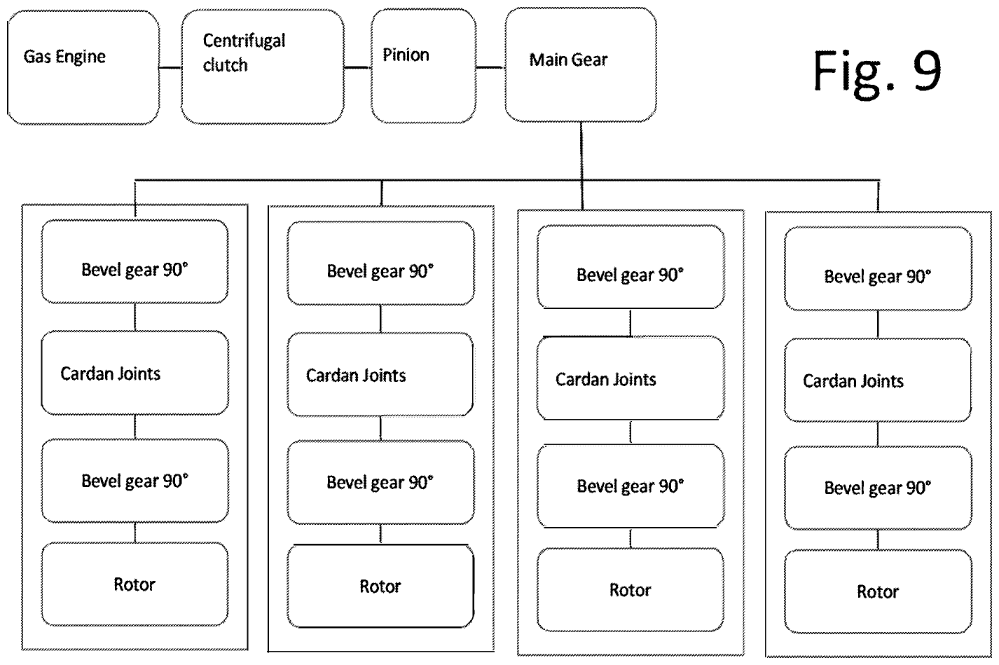

Reference is now made to FIG. 9 presenting a functional diagram showing distribution of a vertically oriented rotational torque generated by a gas engine. A centrifugal clutch serves a mating component between the gas engine and a power train transferring the rotational torque and 4 rotors. The gas engine transfers via the centrifugal clutch the rotating torque to a pinion which is in operative relation with a main gear. Then, the direction of the rotational torque is twice changed by 90° by bevel gears. Smooth inclination of the rotors is enabled by cardan joints introduced into the power train between the bevel gears.

The power distribution system is critical to obtain a good flight performance. Part of the power transmitted by the engine is lost by this set of gears which generate friction during its operation. The position setup of the engine is crucial. An engine setup wherein the crankshaft is on the Z axis provides a better performance in the transmission system than one with a crankshaft on the X axis, by reducing the amount of gears needed, but on the other hand has an engine torque that must be annulated.

1. An automated system for monitoring and treating pests in a crop field; said system comprising:
a. at least one trap for monitoring and identifying pests; said at least one trap having known coordinates; said at least one trap comprising:
i. a pest attraction component;
ii. an adhesive pad configured for immobilizing attracted pests;
iii. a sensor arrangement for locating and identifying said attracted pests;
b. at least one UAV comprising:
i. means for carrying and dispensing at least one chemical;
ii. a positioning unit for tracking coordinates of said at least one UAV at all times;
c. a home base for parking or storing said at least one spraying UAV;
d. at least one database server;
e. a communication unit interconnecting said at least one trap, said at least one home base, said at least one UAV and said at least one database server;
f. software configured for creating and maintaining a map of said pests detected and identified by said at least one trap having known coordinates in said crop field and cultivated plants therewithin; said software configured for determining desirable pest control measures applicable to said crop field and cultivated plants therewithin by means of said at least one UAV carrying and dispensing at least one chemical;
g. a flight controller for controlling said at least one UAV according to pest control measures by determined by said software.

2. The system according to claim 1, wherein said sensor arrangement comprising a sensor configured for locating said pests on said pad and a macrolens camera; said pad and said macrolens camera are movable relative to each other such that such that located pests are in a field of view of said macrolens camera.

3. The system according to claim 1, wherein said locating sensor comprising a line array of light sources and a line array of light detectors mounted at edges of said pad opposite one another; said pests are located according to detecting by said light detectors a shadow created by said pests within light beams created by said light sources.

4. The system according to claim 1, wherein said sensor arrangement comprises an identification information software and database located on said server database.

5. The system according to claim 1, wherein said at least one UAV is configured to have a flight length capacity from about 35 minutes to about 65 minutes, carry a cargo of about 10-200 litres at a speed of about 30-80 km/h.

6. The system according to claim 1, wherein said at least one UAV is able to sustain a constant and uniform payload/takeoff-weight ratio between 0.3 and 0.8 for at least 10 minutes.

7. The system according to claim 1, wherein said at least one UAV has a specific energy capacity over 400 kJ/kg.

8. The system according to claim 1, wherein said at least one UAV is configured to autonomously apply any liquid/solid/gaseous compound for the purpose of preserving or increasing the crop production within one meter of a predefined target under field conditions.

9. The system according to claim 1, wherein said UAV is a multirotor aerial vehicle.

10. The system according to claim 9, wherein at least one rotor of said multirotor aerial vehicle comprises a blade angle governor configured for controlling a rotor lift.

11. The system according to claim 9, wherein at least one rotor of said multirotor aerial vehicle is inclinable from a position thereof vertical relative to a plane formed by members interconnecting rotors of said multirotor aerial vehicle.

12. The system according to claim 9, wherein said aerial vehicle comprises a vertically oriented combustion engine to a plane generated formed by arms supporting rotors.

13. The system according to claim 9, wherein said aerial vehicle has four rotors and said arms form an X-shaped structure.

14. The system according to claim 9, wherein said rotors produce rudder type rotation with lifting forces.

15. The system according to claim 9, wherein said rotors provide Drag forces and Lift to compensate a torque of the engine.

16. The system according to claim 9, wherein said aerial vehicle comprises a main gear distributing rotating torque to each rotor.

17. The system according to claim 9, wherein a power train comprises a combination of said main gear, bevel gears and cardan joints to distribute power to the rotors.

18. The system according to claim 9, wherein rotor axes are inclinable by an angle up to 15° relative to an engine shaft.

19. A trap for monitoring and identifying pests comprising:
a. a pest attraction component;
b. an adhesive pad configured for immobilizing attracted pests;
c. a sensor arrangement for locating and identifying said attracted pests; said sensor arrangement comprising:
i. a sensor configured for locating said pests on said pad and
ii. a macrolens camera;
said pad and said macrolens camera are movable relative to each other such that such that located pests are in a field of view of said macrolens camera; said locating sensor comprising a line array of light sources and a line array of light detectors mounted at edges of said pad opposite one another; said pests are located according to detecting by said light detectors a shadow created by said pests within light beams created by said light sources.

20. A trap for monitoring and identifying pests comprising:
a. a pest attraction component;
b. an adhesive pad configured for immobilizing attracted pests;
c. a sensor arrangement for locating and identifying said attracted pests; said sensor arrangement comprising:
i. a sensor configured for locating said pests on said pad and
ii. a macrolens camera;
said pad and said macrolens camera are movable relative to each other such that such that located pests are in a field of view of said macrolens camera; said locating sensor comprising an array of piezoelectric sensors distributed covering whole capture surface in the form of a grid; said pests are located according to detecting by said piezoelectric sensors the vibration created by said pests.

21. A trap for monitoring and identifying pests comprising:
a. a pest attraction component;
b. an adhesive pad configured for immobilizing attracted pests;
c. a sensor arrangement for locating and identifying said attracted pests; said sensor arrangement comprising:
i. a sensor configured for locating said pests on said pad and
ii. a macrolens camera;
said pad and said macrolens camera are movable relative to each other such that such that located pests are in a field of view of said macrolens camera; said locating sensor comprising an array of capacitive sensors distributed covering whole capture surface in the form of a grid; said pests are located according to detecting by said capacitive sensors a change of the dielectric capacity created by said pests.

22. The trap according to claim 12 comprising a positioning unit for tracking coordinates of said trap.

23. A method of automated monitoring and treating pests in a crop; the method comprising steps of:
a. providing a system for monitoring and treating pests in a crop field; said system comprising:
i. at least one trap for monitoring and identifying pests comprising:
1. a pest attraction component;
2. an adhesive pad configured for immobilizing attracted pests;
3. a sensor arrangement for locating and identifying said attracted pests;
ii. at least one UAV comprising:
1. means for carrying and dispensing at least one chemical;
2. a positioning unit for tracking coordinates of said at least one UAV at all times;
iii. a home base for parking or storing said at least one spraying UAV;
iv. at least one database server;
v. a communication unit interconnecting said at least one trap, said at least one home base, said at least one UAV and said at least one database server;
vi. software configured for creating and maintaining a map of said pests detected and identified by said at least one trap in said crop field and cultivated plants therewithin; said software configured for determining desirable pest control measures applicable to said crop field and cultivated plants therewithin by means of said at least one UAV carrying and dispensing at least one chemical;
vii. a flight controller for controlling said at least one UAV according to pest control measures by determined by said software.
b. informing a user about identifying a predetermined pest species;
c. accepting from a user a service order to carry out a treatment task on a field or on plants being farmed due to the activation of said at least one trap;
d. creating and maintaining a map of the field and plants therewithin using coordinates of said at least one trap;
e. using said map to transform said service order into assignments for said at least one UAV to perform on all or part of the field or for one or more of the plants being farmed;
f. tracking the coordinates of said at least one trap and said at least one UAV at all times;
g. using said coordinates to automatically plot assignments for said at least one UAV and then simultaneously directing said at least one UAV to proceed along individual paths to individual points in the field and to perform a treatment task beginning at those points;
h. controlling traffic as said at least one UAV travel so said at least one UAV avoid colliding with other UAVs or with people or other things; and
i. directing said at least one UAV to a home base for automatic parking or storage when no longer needed.

24. The method according to claim 21, wherein said step of creating and maintaining a map of the field and plants being farmed using coordinates from said at least one trap is performed either at the moment of the installation of said at least one trap or at the moment of receiving said activation alert.
